(19) United States
(12) Patent Application Publication
(10) Pub. No.: US 2024/0022029 A1
(43) Pub. Date: Jan. 18, 2024

(54) Stamped and Bent Part for Conducting Electrical Currents or for Shielding

(71) Applicants: TE Connectivity Germany GmbH, Bensheim (DE); TE Connectivity India Private Limited, Bangalore (IN)

(72) Inventors: Sukshitha H P, Bangalore (IN); Vishnu Patagar, Bangalore (IN); Joachim Barth, Bensheim (DE); Tajdar Khan, Bensheim (DE); Alisa Stalder, Bensheim (DE)

(73) Assignees: TE Connectivity Germany GmbH, Bensheim (DE); TE Connectivity India Private Limited, Bangalore (IN)

(21) Appl. No.: 18/352,340

(22) Filed: Jul. 14, 2023

(30) Foreign Application Priority Data
Jul. 15, 2022 (DE) 202022104000.1

(51) Int. Cl. H01R 13/6594; H01R 13/502; H01R 13/6582; H01R 12/57

(52) U.S. Cl. CPC H01R 13/6594; H01R 13/502; H01R 13/6582; H01R 12/57

(57) ABSTRACT

A stamped and bent part has a plate-shaped section and a pin section projecting from the plate-shaped section. The stamped and bent part has a main grain direction. The pin section has a bending section at which the pin section is bent about a bending axis. The bending axis is perpendicular to the main grain direction.

### CROSS-REFERENCE TO RELATED APPLICATION

This application claims the benefit of the filing date under 35 U.S.C. § 119(a)-(d) of German Patent Application No. 202022104000.1, filed on Jul. 15, 2022.

### FIELD OF THE INVENTION

The invention relates to a stamped and bent part for conducting electrical currents or for shielding. The invention also relates to a shielding plate and an electrical connector.

### BACKGROUND

A stamped and bent part has a contact element for conducting electrical currents or for shielding, in order to be connected to a circuit board, for example. The contact element can be configured as a pin section. The stamped and bent part can be inserted in a housing of an electrical connector, which is connected to a mating connector or a circuit board. Depending on the geometry and position of the electrical connector to the mating connector, it may be necessary for the contact section to occupy little space.

### SUMMARY

A stamped and bent part has a plate-shaped section and a pin section projecting from the plate-shaped section. The stamped and bent part has a main grain direction. The pin section has a bending section at which the pin section is bent about a bending axis. The bending axis is perpendicular to the main grain direction.

### BRIEF DESCRIPTION OF THE DRAWINGS

The invention will be described in more detail in the following with reference to exemplary embodiments illustrated in the drawings, in which:

FIG. 1A is a schematic perspective view of an embodiment of a stamped and bent part;

FIG. 1B is a plan view of the stamped and bent part of FIG. 1A;

FIG. 1C is a schematic diagram of a main grain direction in a pin section of the stamped and bent part;

FIG. 2A is a perspective view of a stamped and bent part according to another embodiment;

FIG. 2B is a plan view of the stamped and bent part of FIG. 2A;

FIG. 3 is a perspective view of a shielding plate according to an embodiment;

FIG. 4A is a perspective view of a shielding plate according to another embodiment;

FIG. 4B is another perspective view of the shielding plate of FIG. 4A in a next step of production;

FIG. 5 is a perspective view of an electrical connector according to an embodiment;

FIG. 6 is a sectional side view of an electrical connector according to an embodiment; and

FIG. 7 is a detail perspective view of a stamped and bent part according to an embodiment.

### DETAILED DESCRIPTION OF THE EMBODIMENT(S)

In the following, the invention is explained in more detail by embodiments with reference to the drawings. The further developments and configurations shown therein are independent of each other and can be combined with each other as required.

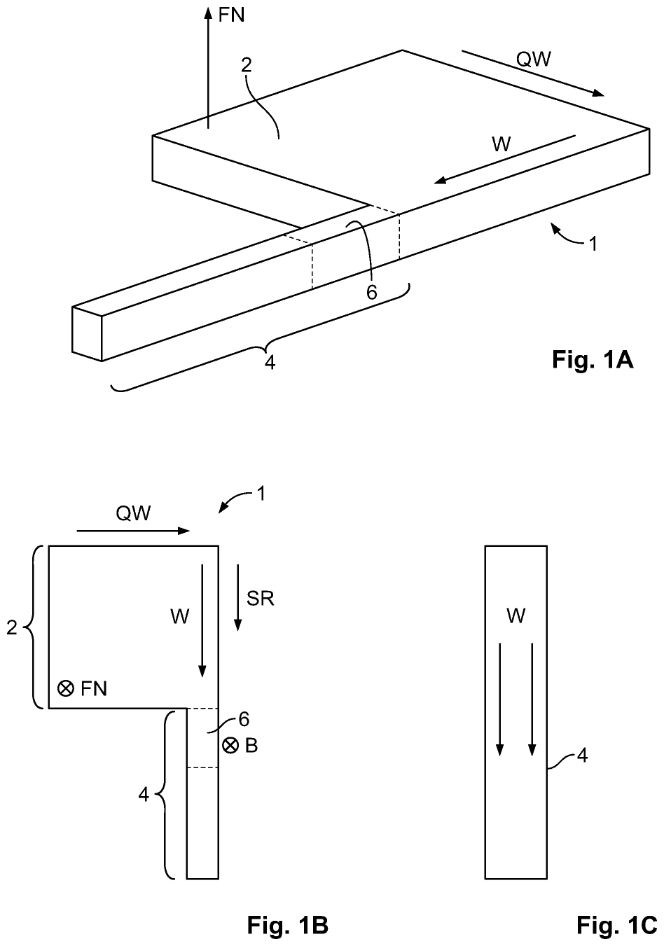

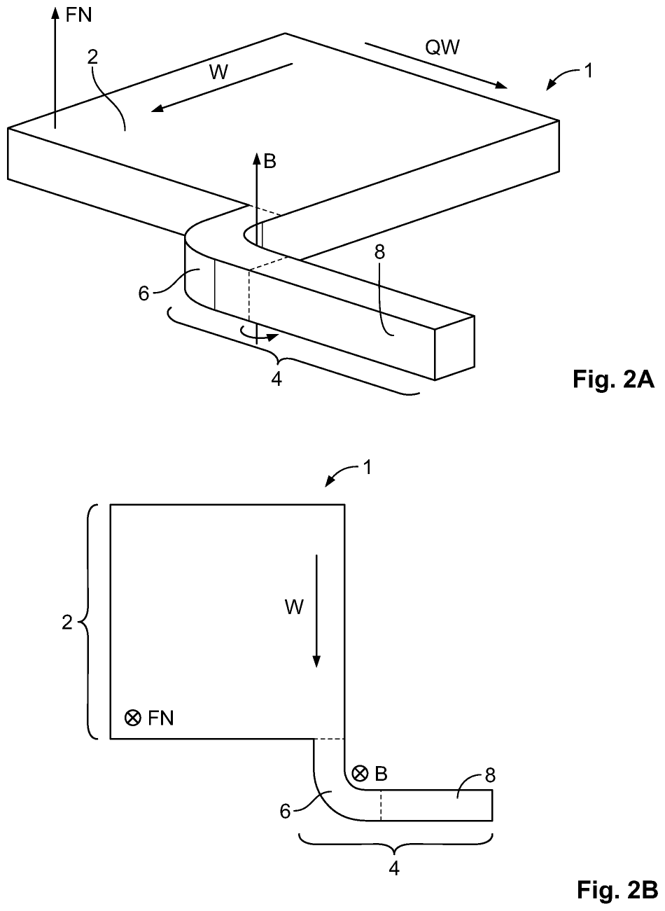

In FIGS. 1A and 1B, an exemplary stamped and bent part 1 is shown before it is formed into the shape according to the invention. The stamped and bent part 1 consists of an electrically conductive material, such as iron or copper. It can also be configured as a metal sheet. By a rolling process, such a stamped and bent part can be manufactured in a substantially plate-shaped form. In this way, a plate with a predetermined thickness is generated. Alternatively, other manufacturing processes can be used to manufacture plates of metal.

By the manufacturing process, the stamped and bent part 1 acquires a characteristic inherent in the workpiece, namely a grain direction or main grain direction W. Without limiting generality, it may be assumed, for example, that the stamped and bent part 1 has been manufactured from sheet metal by a rolling process. By rolling in the rolling direction, the grain structure of the sheet material is changed anisotropically. This anisotropy, which is characteristic of the main grain direction, is reflected (in particular in the case of sheet) as a line-like texture on the material surface. Thus, the main grain direction or rolling direction can be recognized from the line-like texture. Depending on the course of the main grain direction, the bending properties of the workpiece vary. Therefore, it is helpful to know the main grain direction for the forming of a workpiece. The main grain direction W of a stamped and bent part 1 can be determined as a statistical average of the grain orientation over the entire surface of the stamped and bent part 1. Essentially, the grain orientation or main grain orientation W corresponds to the rolling direction of the associated manufacturing process. This configuration not only permits particularly space-saving bending angles with a small bending radius, but is also particularly robust.

The main grain direction W can be distributed essentially homogeneously in the stamped and bent part 1 or a flat side of the shielding plate 10. The main grain direction W is the direction in which at least 50%, 60%, 70%, 80%, 90% or 95% of the grains of the stamped and bent part 1 are aligned.

The stamped and bent part 1 includes a substantially plate-shaped section 2 and a pin section 4 that protrudes from the plate-shaped section 2. As shown in FIGS. 1A and 1B, the pin section 4 protrudes from the plate-shaped section 2 in the same direction as the main grain direction W. FIG. 1C shows a detailed view of the pin section 4 and the main grain direction W inherent in the pin section 4 before the pin section 4 is formed. In the stamped and bent part 1 shown in FIGS. 1A and 1B, the main grain direction W is the same for the plate-shaped section 2 and the pin section 4. A surface normal FN of the plate-shaped section 2 runs parallel to the thickness direction of the stamped and bent part 1. Furthermore, the pin section 4 includes a bending section 6. The bending section 6 is directly adjacent to the plate-shaped section 2 at one end and adjacent to a non-bent part of the pin section 4 at the other end. Thus, the plate-shaped section 2 constitutes a base element from which the bending section 6 protrudes directly. The bending section 6 may be directly adjacent to the base element.

In an embodiment, the pin section 4 may be bent 30°, 45° or 90° about the bending axis.

According to one configuration according to the invention, the pin section 4 is bent about a bending axis B at the bending section 6. The bending axis B runs parallel to the surface normal FN. The bending axis B is thus perpendicular to the main grain direction W. In other words, bending is transverse to the main grain direction or rolling direction.

The main grain direction W is perpendicular to a thickness direction of the stamped and bent part 1, the plate-shaped section 2 and/or the pin section 4.

In an embodiment, the stamped and bent part 1 can be made from one piece.

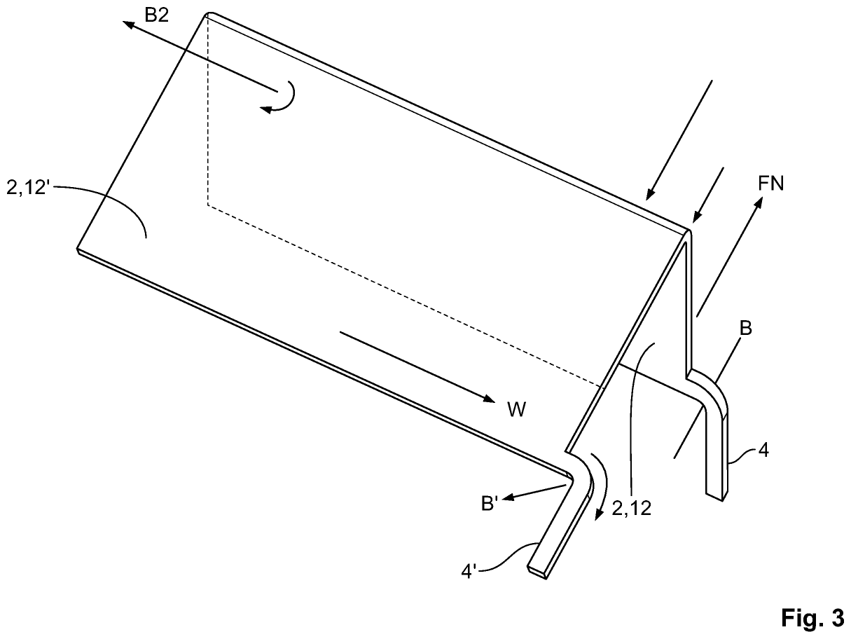

FIGS. 2A and 2B show schematic representations of the stamped and bent part 1 after forming and show an exemplary configuration of the stamped and bent part 1 according to the invention. In this context, the pin section 4 is bent about the bending axis B. When the pin section 4 is formed, the bending section 6 may abut the bending axis B. In the exemplary configuration, the pin section 4 is bent approximately perpendicular to the main grain direction W, so that a non-bent part 8 of the pin section 4 now protrudes transversely to the main grain direction QW. FIG. 2B shows a projection view of the stamped and bent part 1 of FIG. 2A in a plane. The main grain direction W of the stamped and bent part 1 is substantially parallel to a longitudinal edge of the plate-shaped section 2. The stamped and bent part 1 according to the invention, which is generated by forming, lies with its pin section 4 in a plane. Thus, the stamped and bent part 1 can be inserted through a housing opening in a space-saving manner. Deformation can be done by bending or other plastic forming processes.

The stamped and bent part 1 may have a substantially rectangular shape with the pin section 4 protruding from the substantially plate-shaped section 2 and/or being formed from the stamped and bent part. Thus, the pin section 4 projects from the plate-shaped section 2 along the main grain direction W.

The pin section 4 or the non-bent part 8 thereof can be configured as an integrated solder pin. This solder pin can be configured to be connectable to a circuit board.

Furthermore, the pin section 4 or the entire stamped and bent part 1 can be plated. For example, the plating can be done with nickel. Alternatively, the pin section 4 may be plated with another chemical element. Additionally, the entire stamped and bent part 1 may be plated.

FIG. 3 shows an exemplary configuration of a shielding plate 10 according to the invention with two flat sides 12 arranged at an angle to each other, which delimits a volume to be shielded. In the configuration shown in FIG. 3, the two flat sides 12 each configure a plate-shaped section 2 from which a pin section 4 projects. The respective pin section 4 of the flat sides 12 projects from the plate-shaped section 2 in the direction of the main grain direction W of the respective flat side 12. The bending axis B of the pin section 4 associated with one flat side 12 runs differently from the bending axis B′ of the pin section 4′ associated with the other flat side 12′. The respective bending axes B and B′ are each parallel to the surface normals FN of the pin section or plate-shaped section associated with the flat side. Thus, the bending axis B to one flat side 12 is parallel to the surface normal FN and at the same time perpendicular to the main grain direction W of the plate-shaped section forming the flat side 12. The flat sides 12 can be bent at a second bending axis B2 at an angle to one another, the second bending axis B2 being perpendicular to the surface normal FN of the plate-shaped section 2 of a flat side 12 and parallel to the associated main grain direction W thereof.

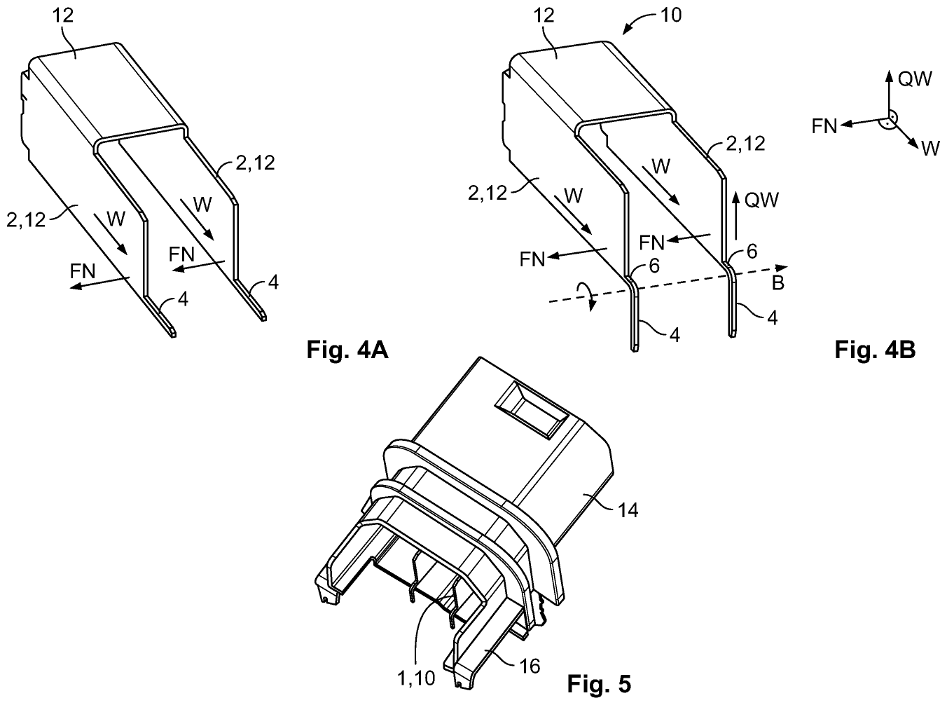

FIG. 4A shows an exemplary configuration of a shielding plate 10 before the pin sections are bent around a bending axis B according to the invention. FIG. 4B shows an exemplary configuration of a shielding plate 10 with three flat sides 12 after the pin sections 4 are bent about the bending axis B according to the invention. In FIGS. 4A and 4B, two parallel flat sides 12 are connected by a third flat side 12 that is perpendicular to the parallel flat sides 12.

FIG. 5 shows an exemplary configuration of an electrical connector 14 according to the invention. A stamped and bent part 1 or a shielding plate 10 may be inserted in the housing 16.

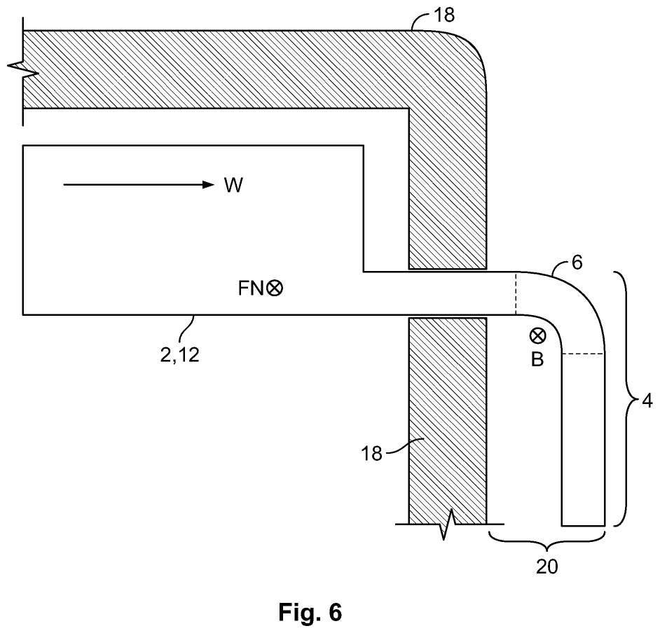

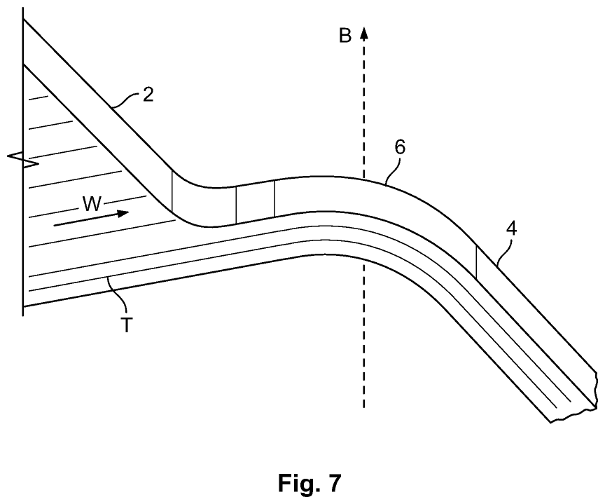

FIG. 6 shows a detailed view of an electrical connector 14 according to the invention. According to this exemplary configuration, the pin section 4 projects through a wall 18 of the housing 16. The plate-shaped section 2 is thereby located on one side of the wall 18 and the bending section 6 of the pin section 4 is located on the other side of the wall 18. In other words, the plate-shaped section 2 is located on the side of the wall 18 that delimits an interior space of the housing, and the bending section 6 of the pin section 4 is located on an outside of the wall 18 that delimits an exterior space of the housing 16. According to this configuration, the bending section 6 and/or the bending axis B about which the pin section 4 is bent is located on the side of the wall where the part of the pin section 4 that protrudes through the wall is located. In an embodiment, the part of the pin section 4 that protrudes through the housing 16 may form a contact section which is accessible outside the housing 16.

An electrical connector 14 according to the invention may be manufactured by the following method: inserting a stamped and bent part 1 into a housing 16 of the electrical connector 14; bending a pin section 4, about a bending axis B, the bending axis B being perpendicular to the main grain direction W of the stamped and bent part 1 and the main grain direction W being parallel with the insertion direction in which the stamped and bent part 1 is inserted into the housing 16.

FIG. 7 is a detail view of a stamped and bent part 1 or shielding plate 10 according to the invention. Based on the line-like texture T of the plate-shaped section 2, the main grain direction W can be seen along the line-like texture T. As previously explained, this texture can be created by a rolling process that works the initial workpiece in a rolling direction. The texture then arises as a line-like pattern that runs along the main grain direction W or rolling direction, because the rolling direction substantially coincides with the grain direction or main grain direction W.

The pin section 4 of the stamped and bent part 1 or shielding plate 10 according to the invention not only saves space, but also allows easy contact with a circuit board, for example by soldering. The orientation of the bending axis B relative to the main grain direction W according to the invention allows an easier and more reliable bending process.

What is claimed is:

1. A stamped and bent part, comprising:
a plate-shaped section; and
a pin section projecting from the plate-shaped section, the stamped and bent part having a main grain direction, the pin section having a bending section at which the pin section is bent about a bending axis, the bending axis is perpendicular to the main grain direction.

2. The stamped and bent part of claim 1, wherein the main grain direction is perpendicular to a thickness direction of the plate-shaped section and/or the pin section.

3. The stamped and bent part of claim 1, wherein the main grain direction is distributed substantially homogeneously in the stamped and bent part.

4. The stamped and bent part of claim 1, wherein the stamped and bent part lies in one plane with the pin section.

5. The stamped and bent part of claim 1, wherein the bending axis is parallel to a surface normal of the plate-shaped section.

6. The stamped and bent part of claim 1, wherein the stamped and bent part has a substantially rectangular shape, the pin section protrudes from the substantially rectangular shape.

7. The stamped and bent part of claim 1, wherein the pin section projects from the plate-shaped section along the main grain direction.

8. The stamped and bent part of claim 1, wherein the pin section is an integral solder pin.

9. The stamped and bent part of claim 1, wherein the pin section is connectable to a circuit board.

10. The stamped and bent part of claim 1, wherein the bending section is directly adjacent to the plate-shaped section at one end and adjacent to a non-bent part of the pin section at another end.

11. The stamped and bent part of claim 1, wherein the pin section is bent by 30°, 45° or 90° about the bending axis.

12. The stamped and bent part of claim 1, wherein the pin section is plated.

13. The stamped and bent part of claim 12, wherein the pin section is plated with nickel.

14. The stamped and bent part of claim 1, wherein the main grain direction corresponds to a rolling direction of the stamped and bent part.

15. The stamped and bent part of claim 1, wherein the plate-shaped section and/or the pin section have the main grain direction.

16. A shielding plate, comprising:
a plurality of flat sides arranged at an angle to one another and delimiting a volume to be shielded, at least one of the flat sides forms a plate-shaped section from which a pin section projects, the plate-shaped section and/or the pin section has a main grain direction, the pin section has a bending section at which the pin section is bent about a bending axis, the bending axis is perpendicular to the main grain direction

17. The shielding plate of claim 16, wherein the flat sides are bent about a second bending axis perpendicular to a surface normal of the plate-shaped section and parallel to the main grain direction.

18. An electrical connector, comprising:
a housing; and
a stamped and bent part inserted into the housing, the stamped and bent part has a plate-shaped section and a pin section projecting from the plate-shaped section, the stamped and bent part has a main grain direction, the pin section has a bending section at which the pin section is bent about a bending axis, the bending axis is perpendicular to the main grain direction.

19. The electrical connector of claim 18, wherein the pin section protrudes through a wall of the housing, a side of the wall facing the plate-shaped section and an opposite side of the wall facing a part of the pin section protruding from the wall, the bending section is on the opposite side of the wall.

20. The electrical connector of claim 19, wherein the part of the pin section protruding through the housing forms a contact section and is accessible outside the housing.
